(19) United States
(12) Patent Application Publication
(10) Pub. No.: US 2005/0061584 A1
(43) Pub. Date: Mar. 24, 2005

(54) Ladder-attached device for holding cordless drill

(76) Inventor: William Berdell Louthen, Santee, CA (US)

Correspondence Address: William B. Louthen, 9926 Donner St., Santee, CA, 92071, US

(21) Appl. No.: 10/666,441

(22) Filed: Sep. 22, 2003

(51) Int. Cl. E06C 5/32

(52) U.S. Cl. 182/129

(57) ABSTRACT

A tool holding device facilitating the retention of a cordless drill, hand tool, paint cans and the like. A rigid hook depends through fastening means from a main bracket assembly that is attached to a ladder and having the ability to swivel so as to maintain center of gravity of a tool attached to the hook while ladder is relocated from one position to another of close proximity. Rigidity of the hook ensures that the worker will be able to replace the tool onto the holding device or to remove it therefrom singlehandedly.

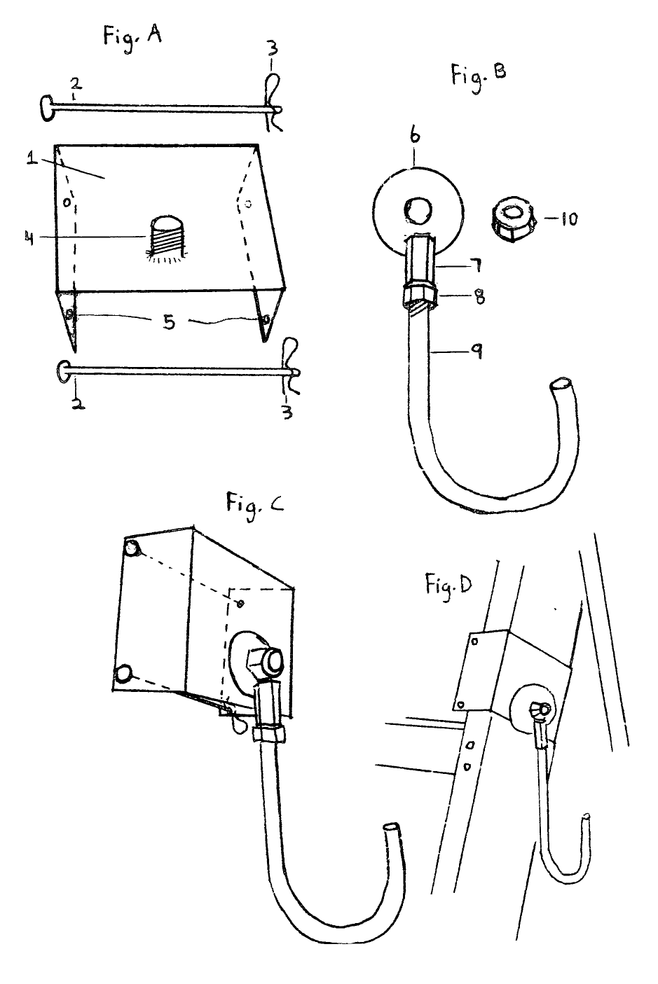

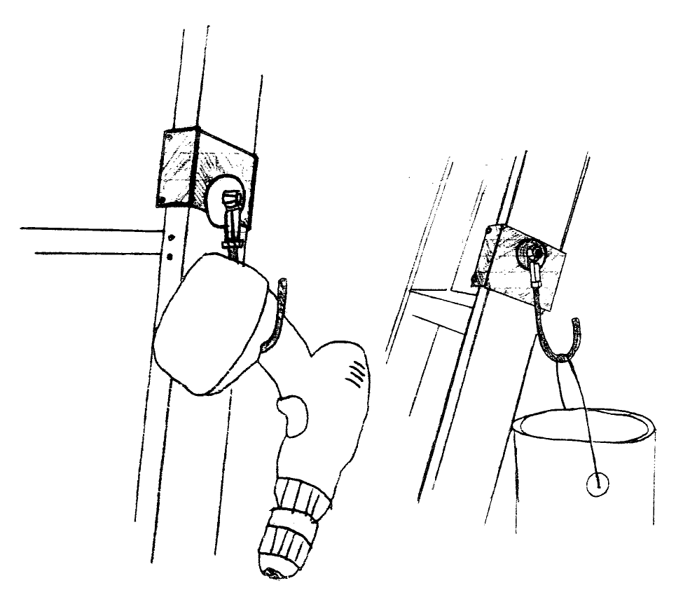

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF INVENTION

The present invention relates to a cordless drill, paint can, tool holder and the like and more particularly pertains to attachment to a ladder for easy access by a user.

### BACKGROUND OF THE INVENTION

The use of tool and paint can holding devices is known in the prior art. More specifically holding devices heretofore devised and utilized for the purpose of holding tools or paint cans therein are known to consist basically of familiar, expected and obvious structural configurations, notwithstanding the myriad of designs encompassed by the crowded prior art which have been developed for the fulfillment of countless objectives and requirements.

Construction workers commonly use cordless drills while atop ladders. After one is done using drill, drill is either set atop ladder or inserted into a holster or hook style holder attached to ones belt. Being attached to ones belt while ascending and descending a ladder is actually quite cumbersome. Let alone the fact that you are walking around a job site with a 5 pound weight attached to ones already overloaded tool belt. To be lugging around this added weight is totally unnecessary.

In this respect, the combination cordless drill, paint container holder according to the present invention substantially departs from the conventional concepts and designs of the prior art, and in doing so provides an apparatus primarily developed for the purpose of attaching a cordless drill or paint container to a ladder for easy access by a user.

The inventive carrying device is a rectangular C-shaped bracket which may be directly attached (without any modification) to a standard ladder and has an attachment at its front face from which a hook depends. In use a cordless drill or paint container hanging from the hook may freely swivel to maintain its center of gravity so as to remain securely attached to the ladder while remaining easily accessible to the workman.

Therefore, it can be appreciated that there exists a continuing need for new and improved holders which can be used for attaching a cordless drill or a paint can tools and the like to a ladder and freeing up ones hands to do work. In this regard, the present invention substantially fulfills this need.

### SUMMARY OF THE INVENTION

In the view of the myriad of patents searched relevant to ladder attached tool, paint container holding devices now present in the prior art, the present invention provides an improved holder. As such the general purpose of the present invention is to provide a new and improved holder and method which has all the advantages of the prior art and none of the disadvantages.

To attain this, the present invention essentially comprises a hook portion dimensioned for receiving a cordless drill therein. The hook is loosely attached to bracket assembly which is dimensioned for receiving the side rail of a ladder. Pins are used for attachment of the bracket, the lower pin resting upon the highest step of the ladder so as to prevent slippage of bracket down side rail of the ladder.

As such, those skilled in the art will appreciate the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved cordless drill, paint container holder which has all the advantages of the prior art tool holding devices and none of the disadvantages.

It is a further object of the present invention to provide a new and improved cordless drill, paint container holder which is of a highly durable and reliable construction.

Even still another object of the present invention is to provide a new and improved cordless drill, paint container holder for attachment to a ladder for easy access by a user.

### BRIEF DESCRIPTION OF DRAWINGS

The present invention will be better understood with reference to the appended drawing sheets, wherein:

Fig. A is a perspective view of the main bracket assembly of the ladder attached tool holding device of the present invention.

Fig. B is a perspective view of the hook assembly of the ladder attached tool holding device of the present invention.

Fig. C is a perspective view of a complete assembly of the ladder attached tool holding device of the present invention.

Fig. D is a perspective vie w of complete assembly of the ladder attached tool holding device of the present invention attached to the side rail of a ladder.

### DETAILED DESCRIPTION OF DRAWING

The present invention relates to a device for securing a cordless drill, paint container, a variety of tools and the like to a ladder. In a first embodiment, the device comprises a bracket 1 pins 2 hitch pin clips 3 and a threaded dowel 4. Referring to fig. A, the device of the present invention comprises a rectangular C-shaped bracket 1 having a front face left face and a right face. Disposed through front face is a threaded dowel 4. Pins 2 are inserted through perforations 5 for securement to the side rail of a ladder. Said pins 2 secured in place by hitch pins 3.

The hook assembly comprises a threaded coupling 7 attached to a washer 6 threaded end of hook 9 is screwed into said coupling 7. Nut 8 is used to lock said hook 9 in place. Locking nut 10 is used to secure washer 6 onto threaded dowel 4 on face of bracket assembly 1.

The lower pin 2 of the ladder attached device rests upon the step of a ladder, thus preventing device from slipping down side rail of the ladder. Perforations 5 are located and dimensioned to fit all fiberglass ladders that are in use in the present. Extra perforations could be easily added to accommodate thinner side rail ladders such as extension ladders and older style wooden ladders.

### Drawing Numeral Reference

1. Main bracket assembly
2. Pins
3. Hitch pin clips (internal type)
4. ⅜ Threaded dowel
5. Holes for pins
6. ⅜ Fender washer
7. 5/16 Threaded rod coupling
8. 5/16 Nut
9. Hook
10. ⅜ Nut (locking type)

### Parts Specification

1. Two 1 3/4×3 inch angle iron welded together or 3 inch flat steel or aluminum×7 inches long drilled and stamped to shape with a 3/8 inch hole in center 3/4 inch from edge, four 11/64 inch holes on sides ½ inch in from top and bottom and 1/4 inch in from sides. Inside diameter is 3 1/4 inch wide by 1½ inch deep.
2. Pins 5/32×3¾ inch long with a 1/16 inch hole 1/8 inch from end
3. 1/16 inch hitch pin (internal type)
4. ⅜ inch threaded dowel 5/8 inch long welded to face of bracket 1
5. 11/64 inch holes
6. ⅜ inch by 1/8 inch thick fender washer
7. 5/16 inch threaded coupling welded to face of washer 6
8. 5/16 inch nut used for locking hook in position
9. 5/16 inch diameter by 9 inch long metal dowel 1¼ inch of end being threaded. Rod bent to shape. Rod threaded into coupling 7
10. ⅜ inch nut (locking type) used to fasten washer 6 to threaded dowel 4

1. A ladder-attached power tool, paint container holding device comprising:
a bracket having a front face a left and a right side face, said left and right side face being perforated with matching apertures and said front face having threaded dowel.
a hook having a first end and a second end said first end having threads.
a large washer with threaded coupling attached, said coupling being threaded so as to receive first end of said hook.
a locking type nut dimensioned to thread to said dowel on front face of said bracket said locking nut used to fasten said washer to said bracket.
two pins inserted into perforations in left and right side face of said bracket for purpose of encompassing and securing said bracket to side rail of a ladder, said pins having been perforated on end so as to receive internal type hitch pin clips used for securement into said bracket.

2. A ladder attached apparatus according to claim 1, wherein said bracket is fabricated from hard or soft metals, metal alloys, hard plastics, flexible plastics or combinations thereof.

3. A ladder attached apparatus according to claim 1, wherein said hook is fabricated from hard or soft metals or metal alloys.
